(19) United States
(12) Patent Application Publication
(10) Pub. No.: US 2017/0010409 A1
(43) Pub. Date: Jan. 12, 2017

(54) IMAGE ACQUISITION DEVICE SUB-MODULE

(71) Applicant: Pixon Technologies Corp., New Taipei City (TW)

(72) Inventor: Yen-Chieh CHEN, New Taipei City (TW)

(21) Appl. No.: 14/795,633

(22) Filed: Jul. 9, 2015

(51) Int. Cl. F21V 8/00; H04N 5/225

(52) U.S. Cl. CPC G02B 6/0088; G02B 6/0083; G02B 6/0055; G02B 6/003; G02B 6/0073; H04N 5/2252; H04N 5/2254

(57) ABSTRACT

An image acquisition device sub-module comprising a linear light source assembly, a lens array, and a sub-module housing is disclosed. Conductive spring pins of a light emitting diode (LED) light source module of the linear light source assembly provide a conductive electrical pathway between the LEDs and a printed circuit board (PCB) of the sub-module housing. The conductive spring pins eliminate need for soldering the LED light source module to the PCB. A plurality of clips on the sub-module housing holds the linear light source to the sub-module housing. A plurality of clamps on the sub-module housing holds the lens array to the sub-module housing. The clips and clamps eliminate need for adhesive to hold the linear light source, the lens array, and the sub-module together.

### BACKGROUND OF THE INVENTION

Field of the Invention

The present invention relates to an image acquisition devices. More specifically, the present invention discloses an image acquisition device sub-module with a sub-module housing mechanically holding a linear light source and a lens array without using solder or adhesive.

Description of the Prior Art

Two main components of conventional scanners are a light source and a lens. The light source is used to illuminate a target and the lens is used to focus the light in order to acquire an image of the target. The quality of the acquired image is greatly dependent on the light source and lens performance. Any inconsistencies in the intensity or uniformity of the light source or the focus of the lens will affect the accuracy of the image.

The quality of the acquired image is also degraded if the scanned target is not in a fixed focal range and exceeds the effective focal range tolerance of the light source and lens.

Additionally, the shapes of conventional light sources and lens are typically designed to make it easier to be fabricated or molded. However, due to the constraints of the design the efficiency of light propagation and focus in terms of diffusion and scattering or uniformity control is limited.

Furthermore, although different approaches have been used to improve the light uniformity and light intensity, greater improvements are still sought after to optimize the energy conservation, improve the intensity and uniformity of the emitted light, enhance the uniformity of beaming light within beaming light's effective focal range, and optimize focus.

Moreover, conventional scanner assembly requires the use of solder and glues to attach or connect components.

Soldering in the production line produces solder fumes which can be detrimental to production worker's health. Additionally, if a soldered component needs to be replaced, the solder needs to be heated and after the component is removed the area must be cleaned in order to install a new component.

When glue is used to attach components, if rework is required it is not only difficult to remove or separate the components but solvents are needed to dissolve the glue and the glue residue must be cleaned and removed from the components in order to reuse the component or components.

Furthermore, soldering and gluing is time consuming and both increase production costs.

Therefore, there is need for an improved light acquisition device sub-module with effective and efficient light source and lens that utilizes mechanical methods to attach and connect components of the sub-module.

### SUMMARY OF THE INVENTION

To achieve these and other advantages and in order to overcome the disadvantages of the conventional methods in accordance with the purpose of the invention as embodied and broadly described herein, the present invention provides an effective image acquisition device sub-module that improves the definition and accuracy of image acquisition while lowering production costs.

The image acquisition device sub-module of the present invention comprises a sub-module housing, a linear light source assembly, and a lens array. Both the linear light source assembly and the lens array are disposed in the sub-module housing.

The linear light source assembly of the present invention comprises a light guide bar with patterned light emitting surface, a reflective light guide holder, and a light emitting diode (LED) light source module.

In the present invention the light guide bar is disposed in the reflective light guide holder and the LED light source module is connected to the light guide holder.

The light guide bar comprises an elongated polygonal transparent material. The light guide bar is disposed in a light guide holder such as, for example, a reflective light guide holder or reflective windowed box. One surface of the light guide bar is a light emitting surface where the light exits.

The LED light source module comprises, for example, a single LED or plurality of LEDs in an LED package. The LED light source module is positioned adjacent to a light-receiving end of the light guide bar.

The light guide holder surrounds the side surfaces of the light guide bar except for the light emitting surface. The light guide holder comprises a windowed box wherein the light guide bar is enclosed in the box except for the light emitting surface, which emits light through the opening or window of the box. The surfaces of the light guide bar surrounded by the reflective light guide holder are reflective surfaces for reflecting light.

The light guide holder further comprises a mating element disposed on an inside end of an end opening of the light guide holder. The LED light source module also comprises a mating element disposed on sides of the LED light source module. The light guide holder mating element and the LED light source module mating element match to allow the LED light source module to connect with the light guide holder. For example, the light guide holder mating element comprises a groove and the LED light source module holder element comprises a ridge. Or, for example, the light guide holder mating element comprises a ridge and the LED light source module holder element comprises a groove. In this way, the mating elements allow the LED light source module to be inserted into the end opening of the light guide holder and be connected to the light guide holder.

The LED light source module comprises a plurality of conductive spring pins as contact points. The plurality of conductive spring pins provide a conductive path between and electrically couple the LEDs of the LED light source module and a printed circuit board (PCB) of the sub-module housing.

Utilizing the plurality of conductive spring pins eliminates the need for soldering. Eliminating soldering reduces costs and eliminates solder fumes and the soldering process from the production line.

After light from the LED light source module enters the light-receiving end or ends of the light guide bar, the light may be reflected off any of the reflective surfaces. The light eventually exits the light guide bar through the light emitting surface. The light emitting surface further comprises a light-scattering pattern that serves to diffuse the light. The light-scattering pattern can comprise a series of notches and/or ridges that are formed such that they vary along the length of the light guide body and may be slightly ramped or sloped from a side view.

As mentioned above, the light-scattering pattern diffuses the light since the light is reflected by one or more of the notches or ridges. The light continues to propagate through the light guide bar from the light-receiving end toward the opposite end before exiting the surface either through a notch or ridge. The light exiting the light emitting surface also refracts at a variety of different angles through the various notches and ridges.

The linear light source assembly enhances the uniformity of beaming light within the beaming light's effective focal range. The linear light source assembly provides a light source with greater emitted or beaming light uniformity that can accurately detect the target without loss caused by uneven or non-uniform intensity. The linear light source with high intensity can repeatedly reflect light in order to optimally conserve the light energy and greatly enhance the intensity.

The lens array comprises an upper lens array section, a lower lens array section, and a lens array holder.

The lens array holder encases the upper and lower lens array sections except for individual lenses disposed of the lens array sections. The lens array holder comprises a black material and blocks unwanted scattered or external light.

The upper lens section and the lower lens section both comprise a plurality of lenses.

The upper lens section comprises a plurality of lenses on a top surface of the upper lens section and a plurality of lenses on a bottom surface of the upper lens section.

The lower lens section comprises a plurality of lenses on a top surface of the lower lens section and a plurality of lenses on a bottom surface of the lower lens section.

A spacer or spacers separate the upper lens section and the lower lens section. The spacer blocks maintains a distance between the upper and lower lens sections and prevents unwanted light from traveling from a lens on the bottom surface of the upper lens section to an adjacent lens disposed on the top surface of the lower lens section rather than the intended lens of the lower lens section. In this way the spacer prevents cross-talk.

The lens array is assembled in the sub-module housing so that the lens array is held at a fixed distance from a sensor that captures the light from the lens array to maintain proper focus.

The sub-module housing comprises a plurality of clamps to clamp the lens array in place to eliminate the need for gluing the lens array to the sub-module housing.

The sub-module housing further comprises a plurality of clips to hold the linear light source assembly in place to eliminate the need for gluing the linear light source assembly to the sub-module housing.

Since the clamps and clips mechanically hold the lens array and the linear light source assembly, glue is not used and production costs are reduced.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1A is 3-dimensional drawing illustrating an image acquisition device sub-module according to an embodiment of the present invention;

FIG. 1B is cross-sectional view drawing illustrating an image acquisition device sub-module according to an embodiment of the present invention;

FIG. 2A is a drawing illustrating a linear light source assembly according to an embodiment of the present invention;

FIG. 2B is an exploded view drawing illustrating a linear light source assembly according to an embodiment of the present invention;

FIG. 3A is a rear view drawing illustrating a light emitting diode light source module of a linear light source module according to an embodiment of the present invention;

FIG. 3B is a side view drawing illustrating a linear light source assembly according to an embodiment of the present invention;

FIG. 3C is a 3-dimensional view drawing illustrating a linear light source assembly according to an embodiment of the present invention;

FIG. 4A is a drawing illustrating an exploded view of a linear light source assembly and a sub-module housing according to an embodiment of the present invention;

FIG. 4B is a cross-sectional view drawing illustrating a linear light source assembly and a sub-module housing according to an embodiment of the present invention;

FIG. 5A is a drawing illustrating an exploded view of a lens array and a sub-module housing according to an embodiment of the present invention; and

FIG. 5B is a cross-sectional view drawing illustrating a lens array and a sub-module housing according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

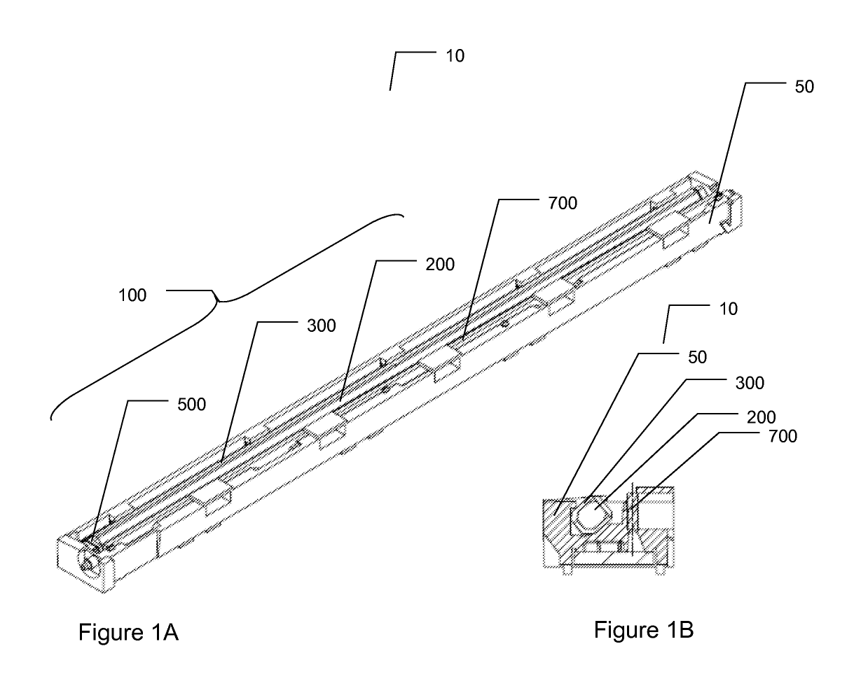

Refer to FIG. 1A, which is 3-dimensional drawing illustrating an image acquisition device sub-module according to an embodiment of the present invention and refer to FIG. 1B, which is cross-sectional view drawing illustrating an image acquisition device sub-module according to an embodiment of the present invention.

The image acquisition device sub-module 10 of the present invention comprises a sub-module housing 50, a linear light source assembly 100, and a lens array 700. Both the linear light source assembly 100 and the lens array 700 are disposed in cavities or openings of the sub-module housing 50.

The linear light source assembly 100 comprises a light guide bar 200, a reflective light guide holder 300, and an LED light source module 500. The linear light source assembly 100 is disposed in a sub-module light source cavity of the sub-module housing 50.

The lens array 700 comprises an upper lens array section, a lower lens array section, and a lens array holder. The lens array 700 is disposed in a sub-module lens array cavity of the sub-module housing 50.

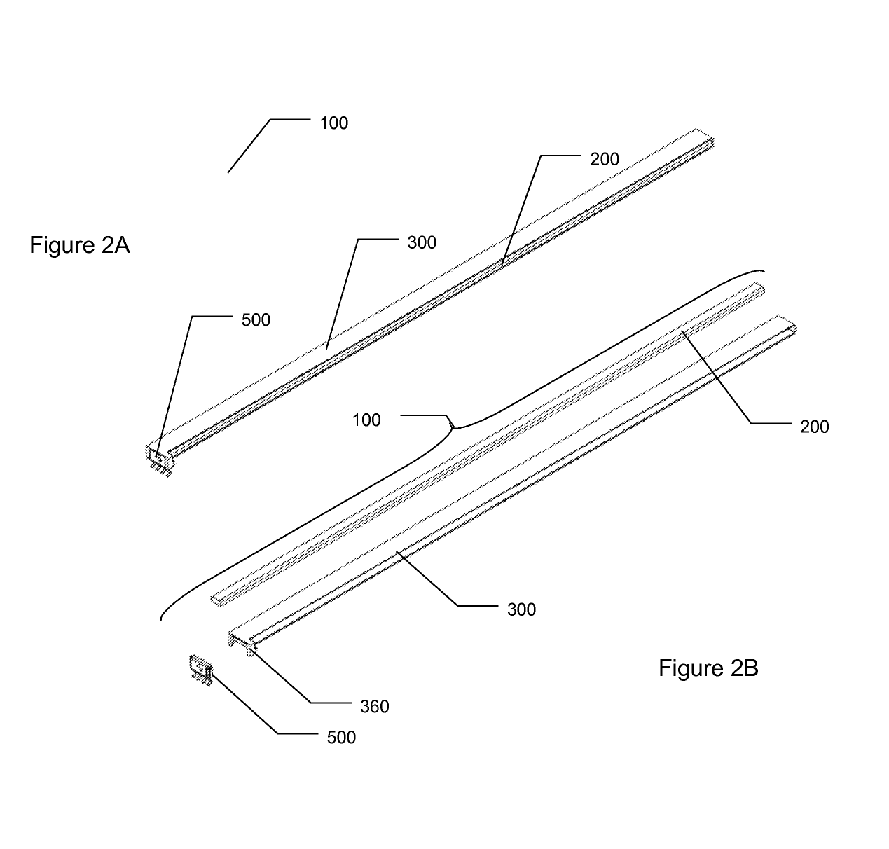

Refer to FIG. 2A, which is a drawing illustrating a linear light source assembly according to an embodiment of the present invention and refer to FIG. 2B, which is an exploded view drawing illustrating a linear light source assembly according to an embodiment of the present invention.

The linear light source assembly 100 of the present invention comprises a light guide bar 200, a reflective light guide holder 300, and a light emitting diode (LED) light source module 500.

The light guide bar 200 is inserted into an opening in the end of the reflective light guide holder 300 until the light guide bar 200 is held inside the interior cavity of the light guide holder 300 that matches the shape of the light guide bar 200.

The LED light source module 500 and an end opening of the light guide holder 300 comprise mating elements such as, for example, grooves and ridges that allow the LED light source module 500 to slide into and connect with the light guide holder 300 and position the LED light source module 500 against the light receiving end of the light guide bar 200.

Electrical power is supplied to the LED light source module 500 from a PCB of the sub-module housing via a plurality of conductive spring pins of the LED light source module 500. When turned on, the LED light source module 500 emits light into the light receiving end of the light guide bar 200. The light travels through the light guide bar 200 and is reflected by the reflective light guide holder 300 and then exits a light emitting surface of the light guide bar 200.

The light guide bar 200 comprises a polygonal cylinder of a transparent or translucent material. The light guide bar 200 is primarily used for converting the spot light source of the LED light source module 500 into a linear light source. One surface of the light guide bar 200 is a light emitting surface for linearly emitting the light. The other surfaces are reflecting surfaces used with the reflective light guide holder 300 for reflecting the light.

In order to improve intensity and increase uniformity, in some embodiments the light emitting surface is sloped and notched to form a light-scattering pattern on the light emitting surface of the light guide bar 200. The notches and ridges are formed on the surface of the light emitting surface. If the notches are formed on a reflective plane, the light is output after being reflected and refracted in the body of the light guide bar 200. The light-scattering pattern not only reduces the influence or shadow of the indentations or notches but also improves the uniformity.

The light is reflected and refracted by the reflective surfaces of the light guide bar 200 and the reflective light guide holder 300, and then output from the light-scattering pattern of the light emitting surface. With different notch angles, the light can be controlled more uniformly. Because the light is directly output after being uniformed, the indentation shadow is not obvious, and the effective focal range tolerance of the light can also be improved.

The reflective light guide holder 300 comprises an elongated body for holding the light guide bar 200 and reflecting light towards the light emitting surface of the light guide bar 200. The internal light guide holder cavity of the light guide holder 300 is shaped to conform with external surfaces of the light guide bar 200.

The LED light source module 500 provides a light source for the linear light source assembly 100. The LED light source module 500 comprises a plurality of LEDs, an LED module housing, and a plurality of conductive spring pins.

The LEDs are disposed in the LED module housing. The plurality of conductive spring pins provide conductive pathways for electrical power from the PCB of the sub-module housing 50 to the LEDs.

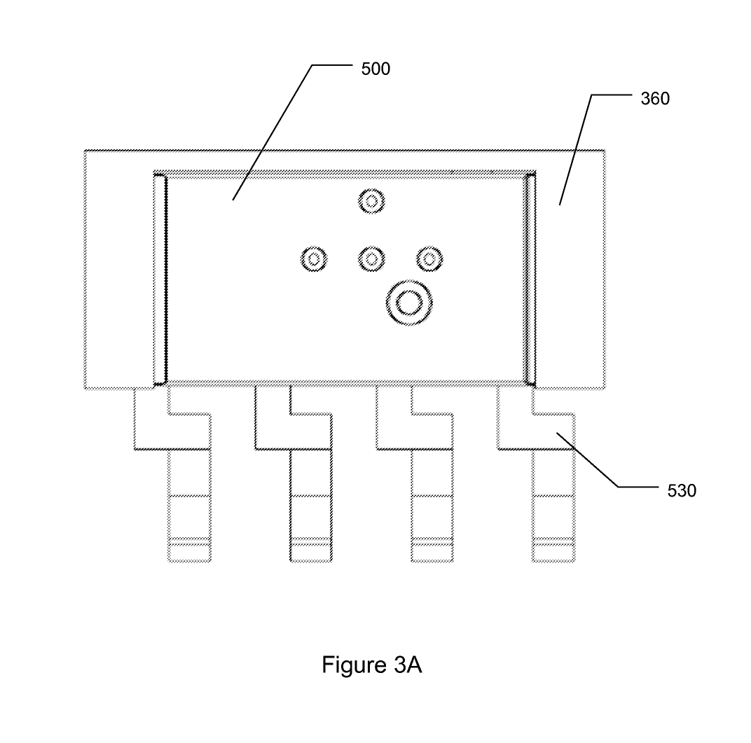

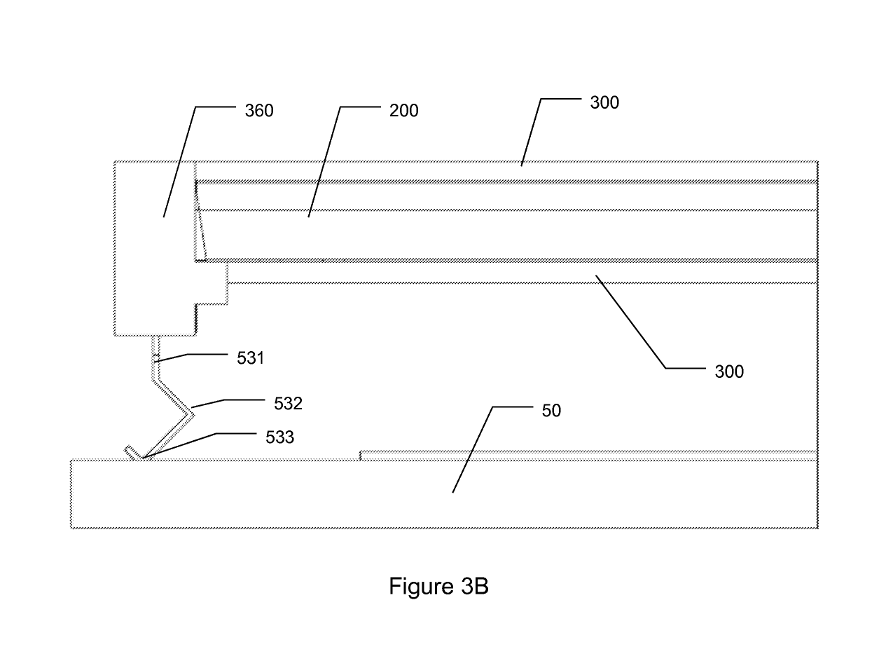

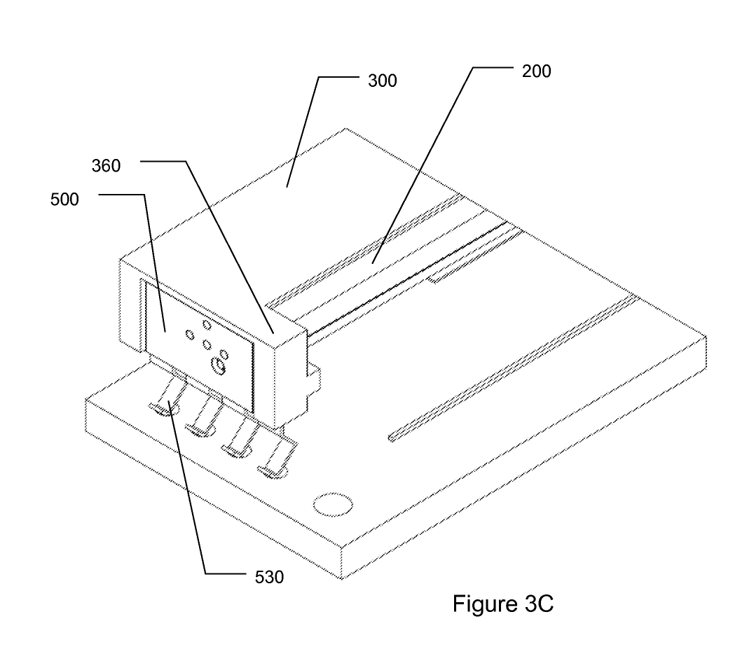

Refer to FIG. 3A, which is a rear view drawing illustrating a light emitting diode light source module of a linear light source module according to an embodiment of the present invention and refer to FIG. 3B, which is a side view drawing illustrating a linear light source assembly according to an embodiment of the present invention, and refer to FIG. 3C, which is a 3-dimensional view drawing illustrating a linear light source assembly according to an embodiment of the present invention.

The LED light source module 500 and a light guide holder end 360 of the light guide holder 300 comprise mating elements such as, for example, grooves and ridges that allow the LED light source module 500 to slide into the light guide holder end 360 and attach the LED light source module 500 to the light guide holder 300 and positions the LED light source module 500 against the light receiving end of the light guide bar 200.

The LED light source module 500 comprises a plurality of conductive spring pins 530. Each conductive spring pin 530 comprises a conductive material that is formed with a body section 531, a knee 532, and a foot 533. The body section 531 is an end of the conductive spring pin 530 electrically coupled to the LEDs of the LED light source module 500. The foot 533 is the other end of the conductive spring pin 530 that contacts conductive traces on the PCB of the sub-module housing 50. The knee 532 is formed in the conductive spring pin 530 between the body section 531 and the foot 533. The knee 532 is formed as an angle section to provide compression and extension to the conductive spring pin 530 in order to maintain the foot 533 in contact with the conductive traces of the PCB.

The flexibility of the conductive spring pins 530 eliminates the need for soldering the LED light source module to the PCB. This provides a cost reduction benefit of the present invention.

Utilizing the conductive spring pins 530 as a contact point for the LEDs to the PCB not only reduces production costs but also reduces solder fumes and soldering processes in the production line.

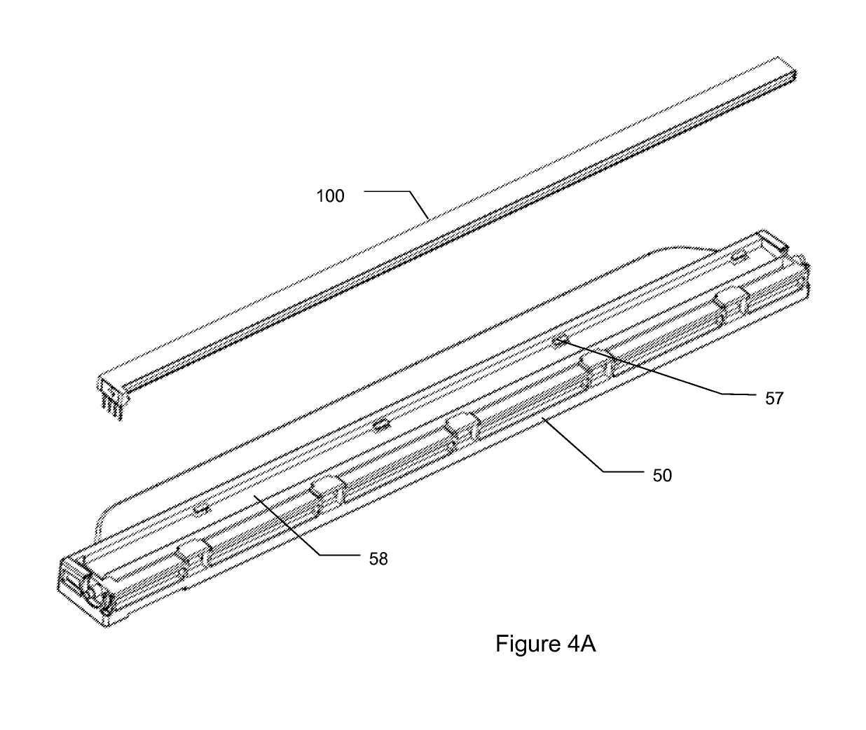

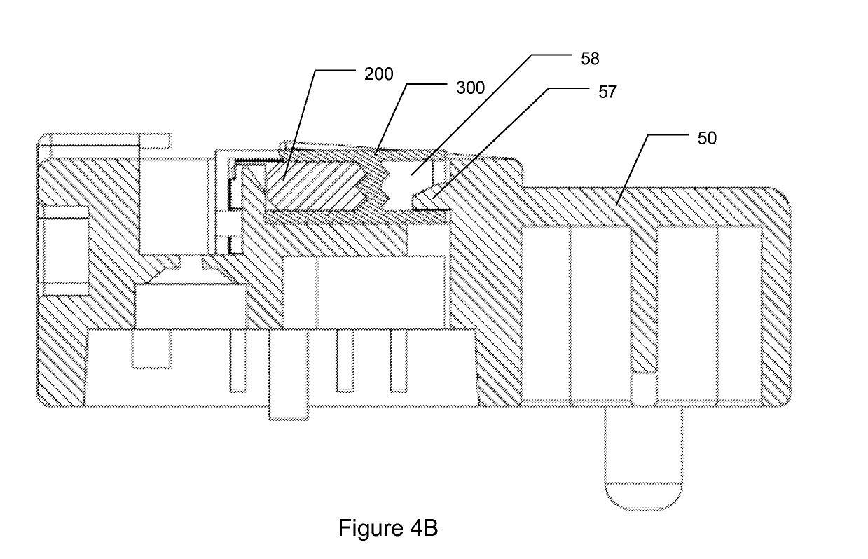

Refer to FIG. 4A, which is a drawing illustrating an exploded view of a linear light source assembly and a sub-module housing according to an embodiment of the present invention and refer to FIG. 4B, which is a cross-sectional view drawing illustrating a linear light source assembly and a sub-module housing according to an embodiment of the present invention.

The sub-module housing 50 further comprises a plurality of clips 57 for holding the linear light source assembly 100 in place to eliminate the need for gluing the linear light source assembly 100 to the sub-module housing 50.

The plurality of clips 57 are disposed on walls of a sub-module linear light source cavity 58 of the sub-module housing 50.

After the linear light source assembly 100 has been assembled, the linear light source assembly 100 is installed in the sub-module housing 50. To install, the linear light source assembly 100 is inserted into the sub-module linear light source cavity 58. While inserting, the linear light source assembly 100 is held at an angle and an edge of the light guide bar holder 300 slides under the plurality of clips 57. The linear light source assembly 100 continues to enter the sub-module linear light source cavity 58 until the edge of the light guide bar holder 300 is under the clips 57 and the linear light source assembly 100 is seated in the sub-module linear light source cavity 58. After insertion, the plurality of clips 57 holds the linear light source assembly 100 and the sub-module housing 50 together.

When assembled, the sub-module housing 50 holds the linear light source assembly 100 in place so that the linear light source assembly 100 remains in correct alignment for optimal performance during use of the main image acquisition device.

Since clips 57 are used instead of glue or adhesive to attach the linear light source to the sub-module housing 50, a cost reduction benefit is realized. Additionally, the linear light source assembly 100 can be removed from the sub-module housing 50 and replaced without requiring solvents or cleaning to remove glue residue.

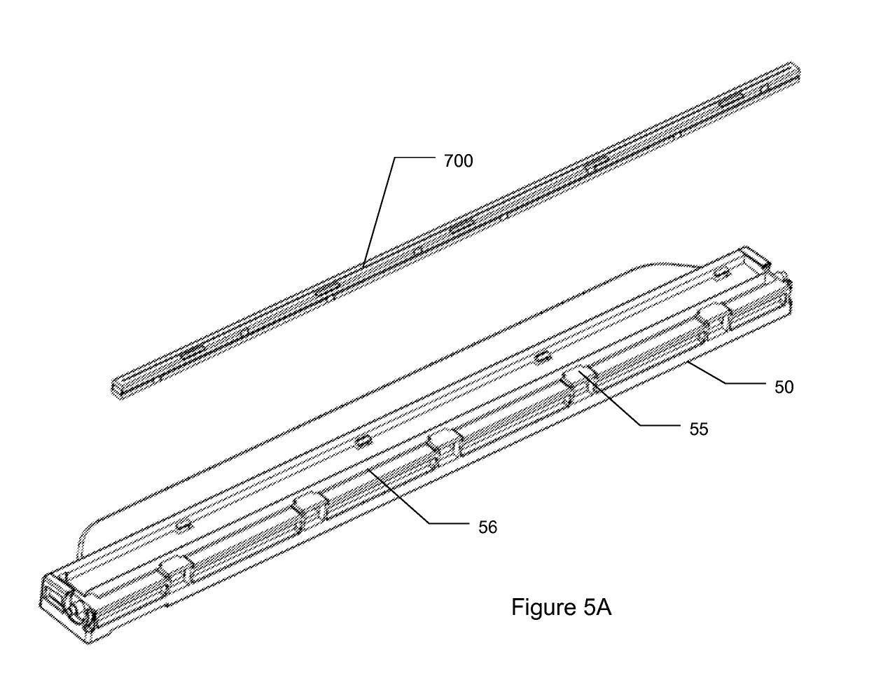

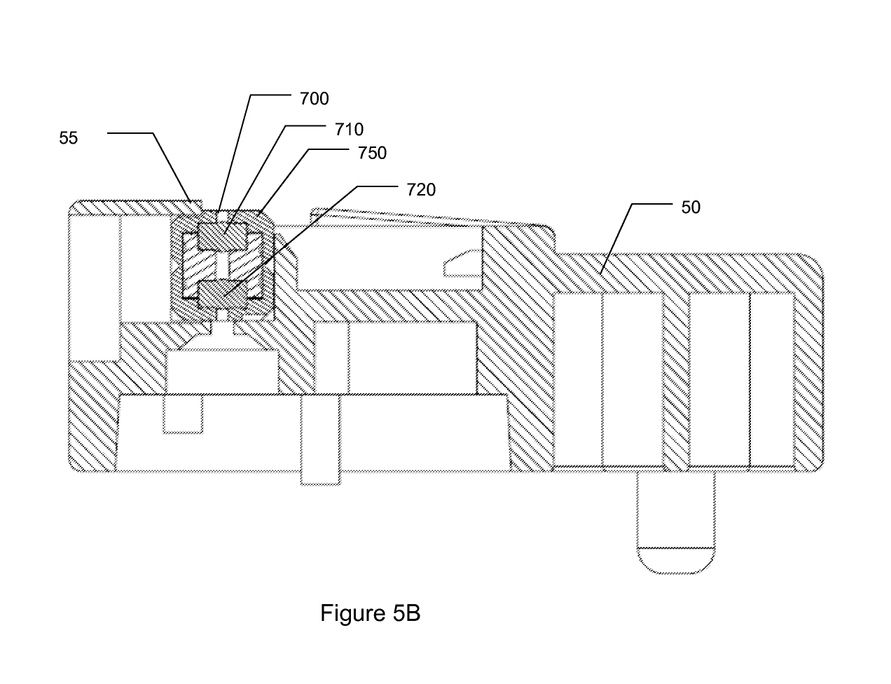

Refer to FIG. 5A, which is a drawing illustrating an exploded view of a lens array and a sub-module housing according to an embodiment of the present invention and refer to FIG. 5B, which is a cross-sectional view drawing illustrating a lens array and a sub-module housing according to an embodiment of the present invention. The sub-module housing 50 further comprises a plurality of clamps 55 for holding the lens array 700 in place to eliminate the need for gluing the lens array 700 to the sub-module housing 50.

The plurality of clamps 55 are disposed on the top of a sub-module lens array cavity 56 of the sub-module housing 50.

After the upper lens section 710 and the lower lens section 720 have been assembled with the lens array holder 750, assembly of the lens array 700 is complete. After the lens array 700 has been assembled, the lens array 700 is installed in the sub-module housing 50.

To install the lens array 700, the side wall of the sub-module lens array cavity 56 is pulled back to widen the mouth of the sub-module lens array cavity 56 until there is enough space for the lens array 700 to be inserted into and seated in the sub-module lens array cavity 56. When the pressure on the side wall is removed, the side wall returns to its original position and the plurality of clamps 55 will contact the top of the lens array holder 750 and hold the lens array 700 and the sub-module housing 50 together.

When assembled, the sub-module housing 50 holds the lens array 700 in place so that the lens array 700 remains in correct alignment and position for optimal performance during use of the main image acquisition device.

Utilizing clamps 55 on the sub-module housing 50 to clamp the lens array 700 in place eliminates the need for gluing the lens array 700 to the sub-module housing 50 since the lens array 700 is mechanically snapped into place. If there is a need to disassemble the sub-module, for example if dust is on the sensor board and reworking of the sub-module is required, the lens array can be easily removed. As a result, the present invention provides another advantage over previous designs where solvents were needed to dissolve glue and then remove the glue residue from the lens in order to reuse the lens.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. An image acquisition device sub-module comprising:
a linear light source assembly comprising:
a light emitting diode light source module comprising a plurality of conductive spring pins;
a lens array; and
a sub-module housing comprising:
a plurality of clips for holding the linear light source assembly in the sub-module housing; and
a plurality of clamps for holding the lens array in the sub-module housing.

2. The image acquisition device sub-module of claim 1, the plurality of clips holding the linear light source assembly by clipping over an edge of a reflective light guide holder.

3. The image acquisition device sub-module of claim 1, the plurality of clamps holding the lens array by clamping over a top of a lens array holder.

4. The image acquisition device sub-module of claim 1, the linear light source assembly comprising:
a light guide bar comprising a light emitting surface and a plurality of reflecting surfaces, the light emitting surface comprising a light-scattering pattern;
a light emitting diode light source module comprising
at least one light emitting diode; and
a plurality of conductive spring pins for electrically coupling the at least one light emitting diode to a printed circuit board without soldering; and
a reflective light guide holder encasing a portion of the light guide bar.

5. The image acquisition device sub-module of claim 1, the lens array comprising:
an upper lens section comprising a plurality of lenses on an upper lens section top surface and a plurality of lenses on an upper lens section bottom surface;
a lower lens section comprising a plurality of lenses on a lower lens section top surface and a plurality of lenses on a lower lens section bottom surface;
a spacer between the upper lens section and the lower lens section; and
a lens array holder holding the upper lens section, the lower lens section, and the spacer.

6. The image acquisition device sub-module of claim 1, where the plurality of clips are disposed on a sidewall of a sub-module linear light source cavity of the sub-module housing.

7. The image acquisition device sub-module of claim 1, where the plurality of clamps are disposed on a top of a sub-module lens array cavity of the sub-module housing.

8. The image acquisition device sub-module of claim 4, wherein the light emitting diode light source module and the reflective light guide holder comprise mating elements to allow the light emitting diode light source module to slide into the reflective light guide holder and attach the light emitting diode light source module to the reflective light guide holder.

9. The image acquisition device sub-module of claim 8, where the mating elements comprise grooves and ridges.

10. The image acquisition device sub-module of claim 1, each of the plurality of conductive spring pins comprising:
a body section connected to the at least one light emitting diode;
a foot for contacting the printed circuit board; and
a knee formed as an angle section to provide compression and extension to the conductive spring pin in order to keep the foot in contact with the printed circuit board.

11. The image acquisition device sub-module of claim 4, the sub-module housing further comprising:
the printed circuit board for electrically coupling with the plurality of conductive spring pins.

12. The image acquisition device sub-module of claim 4, the light-scattering pattern comprising a plurality of notches.

13. An image acquisition device sub-module comprising:
a linear light source assembly comprising:
a light guide bar comprising a light emitting surface and a plurality of reflecting surfaces, the light emitting surface comprising a light-scattering pattern, the light-scattering pattern comprising a plurality of notches;
a light emitting diode light source module comprising
at least one light emitting diode; and
a plurality of conductive spring pins for electrically coupling the at least one light emitting diode to a printed circuit board without soldering; and
a reflective light guide holder encasing a portion of the light guide bar;
a lens array comprising:
an upper lens section comprising a plurality of lenses on an upper lens section top surface and a plurality of lenses on an upper lens section bottom surface;
a lower lens section comprising a plurality of lenses on a lower lens section top surface and a plurality of lenses on a lower lens section bottom surface;
a spacer between the upper lens section and the lower lens section; and
a lens array holder encasing outer surfaces of the upper lens section and the lower lens section except for the plurality of lenses on the upper lens section top surface and the plurality of lenses on the lower lens section bottom surface; and
a sub-module housing comprising:
a plurality of clips for holding the linear light source assembly in the sub-module housing without adhesive; and
a plurality of clamps for holding the lens array in the sub-module housing without adhesive.

14. The image acquisition device sub-module of claim 13, the plurality of clips holding the linear light source assembly by clipping over an edge of the reflective light guide holder.

15. The image acquisition device sub-module of claim 13, the plurality of clamps holding the lens array by clamping over a top of the lens array holder.

16. The image acquisition device sub-module of claim 13, where the plurality of clips are disposed on a sidewall of a sub-module linear light source cavity of the sub-module housing and the plurality of clamps are disposed on a top of a sub-module lens array cavity of the sub-module housing

17. The image acquisition device sub-module of claim 13, wherein the light emitting diode light source module and the reflective light guide holder comprise mating elements to allow the light emitting diode light source module to slide into the reflective light guide holder and attach the light emitting diode light source module to the reflective light guide holder.

18. The image acquisition device sub-module of claim 17, where the mating elements comprise grooves and ridges.

19. The image acquisition device sub-module of claim 13, each of the plurality of conductive spring pins comprising:
a body section connected to the at least one light emitting diode;
a foot for contacting the printed circuit board; and
a knee formed between the body section and the foot as an angle section to provide compression and extension to the conductive spring pin in order to keep the foot in contact with the printed circuit board.

20. An image acquisition device sub-module comprising:
a linear light source assembly comprising:
a light guide bar comprising a light emitting surface and a plurality of reflecting surfaces, the light emitting surface comprising a light-scattering pattern, the light-scattering pattern comprising a plurality of notches;
a light emitting diode light source module comprising
at least one light emitting diode; and
a plurality of conductive spring pins for electrically coupling the at least one light emitting diode to a printed circuit board without soldering, each of the plurality of conductive spring pins comprising:
a body section connected to the at least one light emitting diode;
a foot for contacting the printed circuit board; and
a knee formed as an angle section between the body section and the foot to provide compression and extension to the conductive spring pin in order to keep the foot in contact with the printed circuit board; and
a reflective light guide holder encasing a portion of the light guide bar;
wherein the light emitting diode light source module and the light guide holder comprise mating elements to allow the light emitting diode light source module to slide into the light guide holder and attach the light emitting diode light source module to the light guide holder;
a lens array comprising:
an upper lens section comprising a plurality of lenses on an upper lens section top surface and a plurality of lenses on an upper lens section bottom surface;
a lower lens section comprising a plurality of lenses on a lower lens section top surface and a plurality of lenses on a lower lens section bottom surface;
a spacer between the upper lens section and the lower lens section; and
a lens array holder encasing outer surfaces of the upper lens section and the lower lens section except for the plurality of lenses on the upper lens section top surface and the plurality of lenses on the lower lens section bottom surface; and
a sub-module housing comprising:
the printed circuit board for electrically coupling with the plurality of conductive spring pins;
a sub-module linear light source cavity;
a plurality of clips disposed on a sidewall of the sub-module linear light source cavity for holding the linear light source assembly in the sub-module housing without adhesive;
a sub-module lens array cavity; and
a plurality of clamps disposed on a top of the sub-module lens array cavity for holding the lens array in the sub-module housing without adhesive.
